(19) United States
(12) Patent Application Publication
(10) Pub. No.: US 2012/0103039 A1
(43) Pub. Date: May 3, 2012

(54) METHOD FOR PREPARING SLOW RELEASE FERTILIZERS

(75) Inventor: Jörg Brücher, Domsjo (SE)

(73) Assignee: SVEASKOG FORVALTNINGS AB, Stockholm (SE)

(21) Appl. No.: 13/382,240

(22) PCT Filed: Jul. 2, 2010
(86) PCT No.: PCT/SE2010/050763

§ 371 Date: Jan. 4, 2012

(30) Foreign Application Priority Data
Jul. 7, 2009 (SE) 0950532-2

(51) Int. Cl. C05C 9/00

(52) U.S. Cl. 71/23

(57) ABSTRACT

The present invention relates to a method for preparing a slow-release fertilizer comprising the steps of providing a mixture comprising urea and a first lignin compound; heating the mixture to a temperature in the range of 70-170° C. to obtain a reacted mixture; forming the reacted mixture to obtain a fertilizer composition and forming a coating on the slow-release fertilizer; the coating comprising either at least one resin acid and at least one inorganic salt or a second lignin compound, to obtain the slow-release-fertilizer. Further, the present invention relates to a slow-release fertilizer obtainable by the method. There is also provided a slow-release fertilizer comprising a coating, the coating comprising at least one resin acid and a calcium salt.

### TECHNICAL FIELD OF THE INVENTION

The present invention relates to a method for preparing a slow-release fertilizer and a slow-release fertilizer obtainable by such method. Further, the present invention relates to a method for preparing a coating on a fertilizer.

### BACKGROUND ART

In forestry, growth of plants and trees is generally limited by the supply of nitrogen. Therefore, forest lands are usually fertilized with nitrogen by supplying fertilizers comprising a nitrogen source, such as ammonium nitrate or urea.

Urea (NH₂-CO-NH₂) contains around 48% nitrogen, and is normally hydrolyzed and converted to ammonium and carbon dioxide as it is applied to the soil.

However, due to the high solubility of urea in water, direct fertilization with urea leads to rapid dissolution and leaching of nitrogen to the subsoil and surrounding water. This means that repeated fertilization with a urea-based fertilizer is necessary. Further, direct fertilization with urea may also harm the tress or plants that are fertilized.

To overcome these problems, a slow-release or extended-release of nitrogen is desirable. Slow-release fertilizers comprising a nitrogen source are known in the art. Usually, the slow-release properties are achieved physically with a coating, and one of the first coated fertilizers used were sulfur-coated ureas to adjust the release of nitrogen. However, such coatings may crack and be of uneven thickness, thereby decreasing the slow-release properties of the fertilizer. Further, other coatings used, such as coatings comprising synthetic polymers, may result in undesired spreading of chemicals that are not naturally occurring in the ground.

An example of a slow-release fertilizer comprising urea is disclosed in WO 2005/0007700. This document discloses a method for production of a fertilizer comprising mixing urea and a lignin compound followed by heating. The fertilizer may also comprise mineral fertilizer material and organic fertilizer material. The prepared fertilizer have a documented release of nitrogen to soil for 140 days.

There is however a need in the art for alternative methods for preparing slow-release fertilizers and for slow-release fertilizers capable of releasing nitrogen during several months or years.

### SUMMARY OF THE INVENTION

It is an object/aim of the present invention to provide a fertilizer having slow-release properties.

An object of the invention is also to decrease the number of times the ground has to be fertilized in forestry.

A further object is to provide a fertilizer having a coating that extends the time during which nutrients are released from the fertilizer.

Yet another object of the present invention is to provide a fertilizer comprising components that are by-products from the forest industry.

The above-mentioned objects as well as other objects of the invention, which can be gathered by a person skilled in the art after having studied the description below, are met by the different aspects of the disclosed invention.

The present invention is defined by the appended claims.

As a first aspect of the invention, there is provided a method for preparing a slow-release fertilizer comprising the steps of
a) providing a mixture comprising urea and a first lignin compound;
b) heating the mixture to a temperature in the range of 70-170° C. to obtain a reacted mixture;
c) forming the reacted mixture to obtain fertilizer composition; and
d) forming a coating on the slow-release fertilizer; the coating comprising either at least one resin acid and at least one inorganic salt or a second lignin compound, to obtain said slow-release fertilizer.

In an embodiment of the first aspect, the heating of step b) is to a temperature in the range of 125-135° C.

In an embodiment of the first aspect, the first lignin compound is a lignosulphonate. The lignosulphonate may be sodium lignosulphonate or magnesium lignosulphonate. Further, the lignosulphonate may be ammonium lignosulphonate or calcium lignosulphonate.

In an embodiment of the first aspect, the at least one resin acid is at least one modified resin acid.

In an embodiment of the first aspect, the at least one inorganic salt has a solubility in water of less than 50 g/l at 20° C.

In an embodiment of the first aspect, the at least one inorganic salt is a calcium salt. As an example, the calcium salt may comprise calcium sulphate and/or calcium hydroxyphosphate.

In an embodiment of the first aspect, forming a coating comprising at least one resin acid and at least one organic salt in step d) comprises subjecting the fertilizer composition to a calcium salt and at least one salt of a resin acid. As an example, such a calcium salt may be selected from calcium chloride, calcium nitrate and calcium acetate. In an embodiment of the first aspect, the second lignin compound is reacted with urea.

In an embodiment of the first aspect, steps b) and c) are performed simultaneously.

In an embodiment of the first aspect, the first and/or second lignin compound is provided by a method comprising the steps of:
a1) providing lignocellulosic material;
b1) subjecting the lignocellulosic material to delignification in alkaline conditions to obtain black liquor;
c1) evaporating the black liquor to obtain evaporated black liquor;
d1) subjecting at least part of the evaporated black liquor to carbon dioxide to precipitate the lignin compound; and
e1) recovering the lignin compound.

In an embodiment of the first aspect, at least one salt having a solubility in water of about 50-300 g/l at 20° C. is added to the mixture in step a) and/or to the reacted mixture in step b). The salt may be selected from the group consisting of magnesium sulphate, magnesium oxalate and ammonium oxalate.

In an embodiment of the first aspect, the mixture of step a) is further comprising an acid.

In an embodiment of the first aspect, the forming of step c) is pelletization or granulation.

As a second aspect of the invention, there is provided a slow-release fertilizer obtainable by the method according to the method described above.

As a third aspect of the invention there is provided the use of a lignin compound and urea in a fertilizer, wherein the lignin compound is obtained by a method comprising the steps of:
a2) providing lignocellulosic material;
b2) subjecting the lignocellulosic material to delignification in alkaline conditions to obtain black liquor;
c2) evaporating the black liquor to obtain evaporated black liquor;
d2) subjecting at least part of the evaporated black liquor to carbon dioxide to precipitate the lignin compound; and
e2) recovering the lignin compound.

As a fourth aspect of the invention, there is provided a slow-release fertilizer comprising a coating, the coating comprising at least one resin acid and a calcium salt. As an example, the calcium salt may be selected from calcium sulphate and calcium hydroxyphosphate. As a further example, the at least one calcium salt may have a solubility in water of above 50 g/l at 20° C., such as calcium chloride, calcium nitrate and calcium acetate.

In an embodiment of the fourth aspect, the at least one resin acid is at least one modified resin acid.

As a fifth aspect of the invention, there is provided a slow-release fertilizer comprising a coating, the coating comprising a lignin compound.

In an embodiment of the fifth aspect, the lignin compound is reacted with urea.

In an embodiment of the fifth aspect, the lignin compound is provided by a method comprising the steps of:
a3) providing lignocellulosic material;
b3) subjecting the lignocellulosic material to delignification in alkaline conditions to obtain black liquor;
c3) evaporating the black liquor to obtain evaporated black liquor;
d3) subjecting at least part of the evaporated black liquor to carbon dioxide to precipitate the lignin compound; and
e3) recovering the lignin compound.

As an sixth aspect of the invention, there is provided the use of a lignin compound, or the lignin compound reacted with urea, for coating a fertilizer, wherein the lignin compound is obtained by a method comprising the steps of:
a4) providing lignocellulosic material;
b4) subjecting the lignocellulosic material to delignification in alkaline conditions to obtain black liquor;
c4) evaporating the black liquor to obtain evaporated black liquor;
d4) subjecting at least part of the evaporated black liquor to carbon dioxide to precipitate the lignin compound; and
e4) recovering the lignin compound.

### DETAILED DESCRIPTION OF THE INVENTION

As a first aspect of the invention, there is provided a method for preparing a slow-release fertilizer comprising the steps of

a) providing a mixture comprising urea and a first lignin compound;

b) heating the mixture to a temperature in the range of 70-170° C. to obtain a reacted mixture;

c) forming the reacted mixture to obtain a fertilizer composition; and

d) forming a coating on the slow-release fertilizer; the coating comprising either at least one resin acid and at least one inorganic salt or a second lignin compound, to obtain the slow-release fertilizer.

A “fertilizer” refers to a compound comprising at least one nutrient with the ability to promote plant or tree growth following uptake by plant or tree roots. A “slow-release fertilizer” refers to a fertilizer able to release nutrients to the soil or ground during an extended period of time, such as during at least 1 month.

A “mixture” refers to a substance made by mixing other substances together. The mixture may be a liquid, a solid material, a slurry, dispersion or suspension. As an example, the mixture may be a powder.

A “lignin compound” refers to a compound comprising lignin or a lignin derivative, i.e. a compound derived from lignin.

“Heating the mixture to a temperature in the range of 70-170° C. to obtain a reacted mixture” refers to raising the temperature to 70-170° C. during enough time so that at least a part of the urea and the first lignin compound chemically react with each other so that a reacted mixture is obtained. The urea and the first lignin compound may react with each other in one or several reactions, at least one of which may be a condensation reaction, i.e. a reaction in which functional groups of the urea and the lignin combine and smaller molecules, such as water, are released. As an example, carbonyl groups of urea may react with amino groups of the lignin compound during loss of water. The reacted mixture may for example comprise substituted urea and amides. The reacted mixture may be crosslinked. Crosslinks may for example result from crosslinks between lignin molecules of the lignin compound or urea molecules forming crosslinks within lignin molecules of the lignin compound.

“Forming the reacted mixture to obtain the a fertilizer composition” refers to forming the reacted mixture to any desired form suitable for a fertilizer composition. The forming may be performed at elevated temperature and under a pressure that is higher than atmospheric pressure. Examples of suitable forms include pellets and granules.

A “coating” refers to a layer or covering that covers at least part of the surface of the slow-release fertilizer. Forming a coating on the slow-release fertilizer refers to subjecting the slow-release fertilizer to conditions in which a coating is formed on at least part of the surface of the fertilizer. The coating may comprise at least one resin acid and at least one inorganic salt or the coating may comprise a second lignin compound. It is also to be understood that the coating comprising a resin acid and the at least one inorganic salt may comprise a reacted product formed between the resin acid and the inorganic salt, such as a product formed between a resin acid and an ion of the inorganic salt.

Consequently, in some embodiments of the first aspect, there is provided a method for preparing a slow-release fertilizer comprising the steps of
a) providing a mixture comprising urea and a first lignin compound;
b) heating the mixture to a temperature in the range of 70-170° C. to obtain a reacted mixture;
c) forming the reacted mixture to obtain a fertilizer composition; and
d) forming a coating on the slow-release fertilizer; the coating comprising at least one resin acid and at least one inorganic salt, to obtain the slow-release fertilizer.

Further, in some embodiments of the first aspect, there is provided a method for preparing a slow-release fertilizer comprising the steps of
a) providing a mixture comprising urea and a first lignin compound;
b) heating the mixture to a temperature in the range of 70-170° C. to obtain a reacted mixture;
c) forming the reacted mixture to obtain a fertilizer composition; and
d) forming a coating on the slow-release fertilizer; the coating comprising second lignin compound, to obtain the slow-release fertilizer.

A “resin acid” refers to a terpenoid acid produced by the resin ducts of conifers or synthesized terpenoid acids. In addition to a carboxylic acid group, resin acids may further comprise double bonds. Further, the resin acid may have the basic skeleton of a 3-ring fused system, e.g. with the formula C₁₉H₂₉COOH. The at least one resin acid may be at least one of abietic acid, neoabietic acid, dehydroabietic acid, palustric acid, levopimaric acid, pimaric acid and isopimaric acids.

An “inorganic salt” refers to a mineral salt which is not of organic origin. Examples include calcium hydroxyphosphate and calcium sulphate.

The first aspect of the invention is based on the insight that preparing slow-release fertilizers from a mixture comprising urea and a lignin compound and forming a coating comprising either at least one resin acid and at least one inorganic salt or a second lignin compound on the fertilizer results in a fertilizer having excellent slow-release properties. The inventor has also found that performing the reaction at a temperature in the range of 70-170° C. facilitates the formation of bonds between the urea and the lignin compound. Urea and a lignin compound react directly with each other at temperatures ranging from 70-170° C. This is advantageous since urea easily dissolves in water and therefore leaks to ground water when fertilized in an un-reacted form. Facilitating the formation of as many bonds as possible between urea and a lignin compound by performing the reaction at 70-170° C. thus lead to small amounts of unreacted urea in the fertilizer, which decreases leakage of urea to surrounding water. Heating of the mixture comprising urea and a lignin compound may be performed by increasing the pressure. As an example, if the urea and the lignin compound is in the form of powders, the powders may be melted together under pressure e.g. in extrusion or pelletizing equipment.

Although the present invention is not bound by any specific scientific explanation, the excellent slow-release properties may, at least in part, be due to a combination effect of the fertilizer and the coating, which has low solubility in water, thereby enhancing the slow-release properties of the fertilizer. Moreover, a coating comprising a resin acid and at least one inorganic salt forms layers on the slow-release fertilizers that are hydrophobic and sparingly soluble, thus decreasing the rate at which water can penetrate into the fertilizer, which further increases the life-time of the fertilizer in the ground. Further, the coating is thermoplastic/elastic, thereby decreasing the risk of the formation of cracks in the coating, which may result in an enhanced water penetration. Resin acids are also naturally occurring in the ground, i.e. do only give rise to natural products upon degradation, and have both hydrophobic and antimicrobial properties. Moreover, by-products from the pulp industry may be used for preparing a slow-release fertilizer according to the first aspect of the invention, thereby decreasing the need for transporting compounds used for the preparation of the slow-release fertilizer.

Further, the cost of preparing slow-release fertilizers according to the present disclosure is low, making the fertilizers suitable for a wider market compared to many commercially available slow-release fertilizers.

In a preferred embodiment of the first aspect, the heating of step b) is to a temperature in the range of 125-135° C.

The inventor has found that a temperature at the melting point of urea, which is about 130° C., is the preferred conditions for the reaction of urea with a lignin compound, thus facilitating formation of bonds between urea and the lignin compound.

In an embodiment of the first aspect, the first lignin compound is a lignosulphonate.

Lignosulphonate refers to sulphonated lignin and is an anionic polyelectrolyte. The lignosulphonate may be polydisperse and may have a molecular mass ranging from 1000-1 000 000 Da. Further, the lignosulphonate may be a by-product from the production of wood pulp using sulphite pulping, i.e. pulping in which cellulose fibers are prepared from lignocellulosic materials by using various salts of sulphurous acid, such as sulphites or bisulphites, to extract lignin. The process of sulphite pulping is known to a person skilled in the art. Upon heating, lignosulphonate may react with urea to form a reacted mixture having thermoplastic properties, which implies a very low water solubility of the reacted mixture. Therefore, using a lignin compound comprising lignosulphonate leads to a slow-release fertilizer having very low solubility in water, thus increasing the slow-release properties of the fertilizer.

A fertilizer comprising lignosulphonate and urea have shown to have outstanding slow-release properties as shown in the Examples of the present disclosure.

The lignosulphonate may be provided in the form of a salt with a suitable cation. Examples of suitable cations include Na⁺, Mg²⁺, NH₄⁺ and Ca²⁺. The cations may preferably be Na⁺ or Mg²⁺. Thus, the lignosulphonate may be sodium lignosulphonate or magnesium lignosulphonate.

Sodium lignosulphonate and magnesium lignosulphonate refers to lignosulphonate in which the counter ions to the sulphonate groups are sodium and magnesium, respectively. Sodium lignosulphonate and magnesium lignosulphonate have high molecular weights, thereby making them less soluble in water compared to several other types of lignosulphonates. The low water solubility of a fertilizer prepared from urea and a lignin compound comprising sodium lignosulphonate and/or magnesium lignosulphonate thus increases the slow-release properties of the fertilizer. As other examples, the lignosulphonate may be ammonium lignosulphonate or calcium lignosulphonate or any combination thereof.

In an embodiment of the first aspect of the invention, the at least one resin acid is at least one modified resin acid.

Modified resin acids refer to resin acids reacted with phenols or polyalcohols. Modified resin acids in combination with inorganic salts give rise to a hydrophobic coating of low solubility, thus increasing the slow-release properties of the fertilizer

In embodiments of the first aspect, the resin acids are by-products from the pulp industry. As an example, the resin acids may be abietic acid dehydroabietic acid and pimaric acid that originate from soft timbers or conifers used in the pulp industry.

Moreover, the forming of a coating of step d) may further comprise adding turpentine to the at least one resin acid and/or modified resin acid to increase the antimicrobial properties, such as turpentine in an amount of 0.1-2% (w/w), such as 0.2-1% (w/w).

In an embodiment of the first aspect of the invention, the at least one inorganic salt has a solubility in water of less than 50 g/l at 20° C.

In embodiments of the first aspect, the at least one inorganic salt is a calcium salt.

The inventor has found that calcium salts are suitable to use as a coating in combination with resin acids. As an example, the calcium salt may comprise calcium sulphate and/or calcium hydroxyphosphate. These salts have a very low solubility in water and may thus form a coating together with the resin acids that decreases the rate at which water penetrates into the slow-release fertilizer and thereby extending the period of time at which nutrients are released from the fertilizer.

Further, forming a coating comprising at least one resin acid and at least one calcium salt in step d) may comprise subjecting the fertilizer composition to a calcium salt having a solubility in water of above 50 g/l at 20° C. and at least one salt of a resin acid. The fertilizer may first be subjected to the resin acid and then further be subjected to the calcium salt, or vice versa.

The inventor has found that calcium salts having a relative high solubility in water may be used to form sparingly soluble salts (soaps) with resin acids, which also act as a slow-release coating on fertilizers. As an example, the calcium salt may have a solubility of above 100 g/l at 20° C., such as above 200 g/l at 20° C., such as above 300 g/l at 20° C. As examples, the calcium salts having a relative high solubility in water may be selected from calcium chloride, calcium nitrate and calcium acetate.

It is to be understood that calcium salts of low solubility, such as calcium sulphate and calcium hydroxyphosphate may be used in combination with resin acids and calcium salts of high solubility, such as calcium chloride, calcium nitrate and calcium acetate, to form the coating on the fertilizer.

The salt of a resin acid may for example be a potassium salt of a resin acid.

In an embodiment of the first aspect of the invention, the second lignin compound is reacted with urea.

A compound reacted with urea refers to a compound that has participated in a chemical reaction with urea. Such a chemical reaction may for a example be a condensation reaction between the compound and urea.

A lignin compound reacted with urea may affect the water solubility of the lignin compound, which may increase the elastic properties of the lignin compound, thereby facilitating the formation of a coating comprising a second lignin compound on the slow-release-fertilizer.

In another embodiment of the first aspect of the invention steps b) and c) are performed simultaneously. Thus, heating the mixture to obtain a reacted mixture and forming the reacted mixture to obtain the slow-release fertilizer may be performed simultaneously, e.g. in an extrusion process. Such extrusion process may be performed by heating the mixture and forcing the mixture through a die of desired shape. Different extrusion processes are known to the skilled person.

In another embodiment of the first aspect of the invention, the first and/or second lignin compound is provided by a method comprising the steps of:

a1) providing lignocellulosic material;

b1) subjecting the lignocellulosic material to delignification in alkaline conditions to obtain black liquor;

c1) evaporating the black liquor to obtain evaporated black liquor;

d1) subjecting at least part of the evaporated black liquor to carbon dioxide to precipitate the lignin compound; and

e1) recovering the lignin compound.

“Lignocellulosic material” refers to material comprising lignin and cellulose.

Subjecting the lignocellulosic material to delignification in alkaline conditions refers to subjecting the lignocellulosic material to an alkaline fluid, such as an alkaline gas or liquid having a pH above 10, such as above 13, to liberate lignin from the cellulose. The alkaline fluid added may have a temperature above 90° C., such as above 100° C.

“Black liquor” refers to an aqueous solution comprising lignin residues and the inorganic chemicals used to delignify the lignocellulosic material in alkaline conditions.

Evaporating black liquor refers to subjecting the black liquor to conditions so that liquid is driven off from the black liquor. Evaporation may be effected by heating and may lead to an evaporated black liquor comprising at least 50% dry matter, such as at least 70% dry matter.

Subjecting at least part of the evaporated black liquor to carbon dioxide to precipitate the lignin compound refers to injecting carbon dioxide to the evaporated black liquor to decrease the pH so that at least some lignin residue, i.e. the lignin compound, is precipitated.

Recovering the lignin compound refers to extracting the precipitated lignin compound from the evaporated black liquor that has been subjected to carbon dioxide.

A lignin compound is provided by steps a1)-e1) above, may react with urea to form a product that is less soluble in water compared to a product obtained using e.g. conventional lignin. Therefore, a slow-release fertilizer comprising urea and a first lignin compound provided by steps a1)-e1) above facilitates a more prolonged release of nitrogen in the ground.

Further, if the second lignin compound is provided by steps a1)-e1) above, it may form a coating that is very hydrophobic and thus decreases water penetration into the pellet.

The black liquor may also be black liquor obtained by the Kraft process (also known as the sulphate process) of the pulping industry, in which black liquor is obtained by treating lignocellulosic material with a mixture of sodium hydroxide and sodium sulphide to delignify the lignocellulosic material. The Kraft process is well known to the skilled person. Thus, in an embodiment of the first aspect of the invention, the first and/or the second lignin compound is provided by a method comprising the steps of:
a11) providing black liquor obtained from the Kraft process;
b11) evaporating the black liquor to obtain evaporated black liquor;
c11) subjecting at least part of the evaporated black liquor to carbon dioxide to precipitate the lignin compound; and
d11) recovering the lignin compound.

In an embodiment of the first aspect of the invention, the first and/or the second lignin compound is provided by the LignoBoost™ method. The LignoBoost™ method is a method known in the art for providing a lignin compound.

In an embodiment of the first aspect of the invention, the second lignin compound is provided either by steps a1)-e1) or by steps a11)-d11) above and further reacted with urea before forming a coating on the slow-release fertilizer in step d) of the method according to the first aspect of the invention.

In a further embodiment of the first aspect of the invention, the second lignin compound is provided by the LignoBoost™ method and further reacted with urea before forming a coating on the slow-release fertilizer in step d) of the method according to the first aspect of the invention

In another embodiment of the first aspect of the invention, at least one salt having a solubility in water of about 50-300 g/l at 20° C. is added to the mixture in step a) and/or to the reacted mixture in step b).

This embodiment is based on the insight that adding at least one salt having a solubility in water of about 50-300 g/l at 20° C. during to the mixture in step a) and/or to the reacted mixture in step b) during the process of preparing a slow-release fertilizer, i.e. adding such salts before coating the fertilizers, increases the slow-release properties of the slow-release fertilizer, i.e. the time during which the fertilizer releases nutrients such as nitrogen. This is because the at least one salt a solubility in water of about 50-300 g/l at 20° C. slowly dissolves as water penetrates into the slow-release fertilizer, thus increasing the salinity of the water that directly surrounds the slow-release fertilizer in the ground. An increased salinity of the water surrounding the slow-release fertilizer lowers the dissolution rate of the nitrogen from the slow-release fertilizer, which in turn extends the time at which nitrogen is released. The inventor has found that addition of a salt having a solubility of below 50 g/l at 20° C. has little effect since it will only marginally increase the ion strength of the surrounding water and therefore not provide for an additional slow-release effect. Further, the inventor has found that addition of a salt having a solubility of above 300 g/l at 20° C. also has little effect on the slow-release properties since the salt will dissolve too fast and generate an ionic strength that is unnecessary high. Thus, it is advantageous that the salt added to the mixture in step a) and/or to the reacted mixture in step b) has a solubility in the interval of about 50-300 g/l at 20° C.

The at least one salt having a solubility in water of about 50-300 g/l at 20° C. may be selected from the group consisting of magnesium sulphate, magnesium oxalate and ammonium oxalate.

In an embodiment of the first aspect of the invention, the mixture of step a) is further comprising an acid.

An acid refers to any chemical compound that is an proton donor and that increases the hydrogen ion activity when dissolved in water. The acid may be a strong acid, i.e. an acid having a pKa <−1.74. If the mixture of step a) is comprising an acid, it may catalyze a condensation reaction between urea and the first lignin compound, thus promoting formation of a reacted mixture.

In an embodiment of the first aspect of the invention the forming of step c) is pelletization or granulation.

Pelletization refers to forming of pellets and granulation refers to the formation of granules, which may be in any convenient form for a slow-release fertilizer. Forms and dimensions of pellets and granules are well known to a person skilled in the art.

As a second aspect of the invention, there is provided a slow-release fertilizer obtainable by the method described above.

As a third aspect of the invention, there is provided the use of a lignin compound and urea in a fertilizer, wherein the lignin compound is obtained by a method comprising the steps of:

a2) providing lignocellulosic material;
b2) subjecting the lignocellulosic material to delignification in alkaline conditions to obtain black liquor;

c2) evaporating the black liquor to obtain evaporated black liquor;

d2) subjecting at least part of the evaporated black liquor to carbon dioxide to precipitate the lignin compound; and

e2) recovering the lignin compound.

The terms and definitions used in connection with the fourth aspect of the invention are the same as referred to above. Using a lignin compound obtained by steps a2)-e2) above and urea in a fertilizer facilitates a more prolonged release of nutrients, since such a lignin compound and urea may form a product that has a very low solubility in water.

As a fourth aspect of the invention, there is provided a slow-release fertilizer comprising a coating, the coating comprisingat least one resin acid and a calcium salt.

As discussed in relation to the first aspect above, the inventor has found that calcium salts are suitable to use as a coating in combination with resin acids.

As an example, the calcium salts may be calcium sulphate and/or calcium hydroxyphosphate. At least one resin acid and calcium sulphate and/or calcium hydroxyphosphate form hydrophobic and sparingly water soluble layers as a coating on fertilizers. This decreases the rate at which water can penetrate into the fertilizer, thereby increasing life-time of the fertilizer in the ground. Resin acids are also naturally occurring in the ground, i.e. do only give rise to natural products upon degradation, and have both hydrophobic and antimicrobial properties.

As a further example, the calcium salt may have a solubility in water of above 50 g/l at 20° C., such as above 100 g/l at 20° C., such as above 200 g/l at 20° C., such as above 300 g/l at 20° C. Such salts may form sparingly soluble salts (soaps) with resin acids which act as a slow-release coating on a fertilizer. As examples, such calcium salts may be selected from calcium chloride, calcium nitrate and calcium acetate

In an embodiment of the fourth aspect, the at least one resin acid is at least one modified resin acid.

As a fifth aspect of the invention, there is provided a slow-release fertilizer comprising a coating, the coating comprising a lignin compound.

In an embodiment of the fifth aspect, the lignin compound is reacted with urea.

A lignin compound reacted with urea has very low solubility in water and are thus suitable as coatings for slow-release fertilizers.

In an embodiment of the fifth aspect of the invention, the lignin compound is provided by a method comprising the steps of:

a3) providing lignocellulosic material;

b3) subjecting the lignocellulosic material to delignification in alkaline conditions to obtain black liquor;

c3) evaporating the black liquor to obtain evaporated black liquor;

d3) subjecting at least part of the evaporated black liquor to carbon dioxide to precipitate the lignin compound; and

e3) recovering the lignin compound.

Further, the lignin compound recovered from step e3) may further be reacted with urea. Such lignin compounds have very low solubility in water and are thus suitable as coatings for slow-release fertilizers.

The lignin compound may also be prepared by the LignoBoost™ method and may further be reacted with urea.

In a sixth aspect of the invention, there is provided the use of a lignin compound, or the lignin compound reacted with urea, for coating a fertilizer, wherein the lignin compound is obtained by a method comprising the steps of:

a4) providing lignocellulosic material;

b4) subjecting the lignocellulosic material to delignification in alkaline conditions to obtain black liquor;

c4) evaporating the black liquor to obtain evaporated black liquor;

d4) subjecting at least part of the evaporated black liquor to carbon dioxide to precipitate the lignin compound; and

e4) recovering the lignin compound.

A lignin compound obtained by steps a4)-b4), or such a lignin compound reacted with urea, may form a coating that is sparingly soluble in water, thereby decreasing the rate at which water penetrates into the fertilizer, which in turn increases the period during which nutrients may be released from the fertilizer.

### BRIEF DESCRIPTION OF THE DRAWINGS

FIG. 1 shows the total biomass, root and shoot (g dry weight) of two year old Picea abies seedlings grown for 10 weeks on a fertilizer comprising lignosulphonate and urea (solid squares) or the commercial fertilizer Silvamix (open triangles), using addition of three different nitrogen levels: 100, 200 and 600 mg, respectively. Seedlings that are not fertilized at all (only addition of water) are displayed as a reference (solid circles).

### EXAMPLES

The following non-limiting example will further illustrate the present invention.

### Example 1

### Preparation of Slow Release Fertilizer Comprising Urea and Lignosulfonate

Equal amounts of lignosulphonate and urea where thoroughly mixed and heated to the melting point of the urea, about 130° C. Upon melting of the urea fraction, the mixture formed a homogenous, brownish phase which could be casted in desired forms, e.g. as pellets, bars or chip-like forms. During cooling, the hot mixture hardened slowly to a glass-like phase. During hardening, the material was kneadable for 5-15 min, depending on the surrounding temperature. When material was kneadable, fine crystalline substances materials like insoluble salts could be adhered to the surface of the formulation, thus forming a barrier or coating against water penetration.

A coating of low soluble calcium salts were formed on the pellets prepared according to the above procedure by:

a) spraying a concentrated solution of a calcium chloride (a salt with high water solubility) on the pellets, and

b) subjecting the pellets to a potassium salt of abietic acid.

The calcium salt and the potassium salt of abietic acid reacted and formed a coating on the surface of the pellets.

Dissolution of the coated pellets was compared with commercial slow release products in the following laboratory tests:

About 15 g of the pellets (20 mm diameter) coated with the calcium salt of a abietic acid described in the procedure above were placed in a 2 l beaker with an excess of water, 1.5 l at 20° C.

For comparison, the same tests were carried out with three commercial formulations, Silvagen 80 TE (Ecolab, Znojmo, Czech Republic), Basacote 6 MK, and Basacote 12 M. (Compo GmbH &Co KG, Munster, Germany).

Silvagen 80 TE is a slow-release fertilizer in which the nitrogen is present as formaldehyde urea and is described as having a disintegration time of 3-5 months. The Basacotes are konventional NPK-fertilizers, and slow-release properteos of these fertilizers are achieved by a membrane of polysulfonic acid. According to the specification of the manufacturer, Basacote 6 MK has a release time of 6 months, whereas Basacote 12 M will release its fertilizer content within 12 months. Under the experimental conditions, disintegration and nutrient release of the formulations described is accelerated and will occur within 3-7 days.

In these tests, the pellets based on urea-lignosulphonate coated with the calcium salt of abietic acid had a disintegration time somewhat longer than the Silvamix product. Thus, Example 1 shows that slow-release fertilizers prepared according to the present invention disintegrates at a rate similar to those of commercially available fertilizers.

### Example 2

### Total Biomass of Picea abies Fertilized with Different Types of Fertilizers

### Materials and Methods

The total biomass (root and shoot) of spruce seedlings were analysed in a pot experiment during the winter 2009. The spruce seedlings were fertilized with pellets of slow-release fertilizers prepared as in Example 1 above. The pellets were thus based on urea-lignosulphonate coated with the calcium salt of abietic acid. Further, for comparison, spruce seedlings were also fertilized with a commercially available fertilizer, Silvamix, which is a slow-reease fertilizer in which the nitrogen is present as formaldehyde urea. Two year old spruce (Picea abies) seedlings with a low nitrogen content (1.4%) were planted in squared pots with a volume of 3 liters in an nitrogen free peat with a pH of 5.5. The fertilizers prepared according to Example 1 above or Silvamix were added in amounts corresponding to three different nitrogen levels, 100, 200 and 600 mg nitrogen, respectively. As a comparison, some seedlings were not fertilized at all (only addition of water). The different fertilizers were added as dry material in one single application and placed centrally in between the plant and the side of the pot mimicking forest fertilization. The plants were grown in a temperature of 20° C. for ten weeks with a 22 hour day (12 000 lux). The plants were regularly watered when needed (on average once a day) and each week a nitrogen-free free fertilizer containing all other required nutrients, solved in water, was added in corresponding amount and ratio according to the ordinary plantnutrient solution used in commercial plantbreeding (Wallco). After ten weeks the plants were harvested, rinsed and divided into shoot and root. The material was left to airdry for one month before it was dried in an oven (70° C. for 12 h). Shoots and roots were weighed separately.

### Results

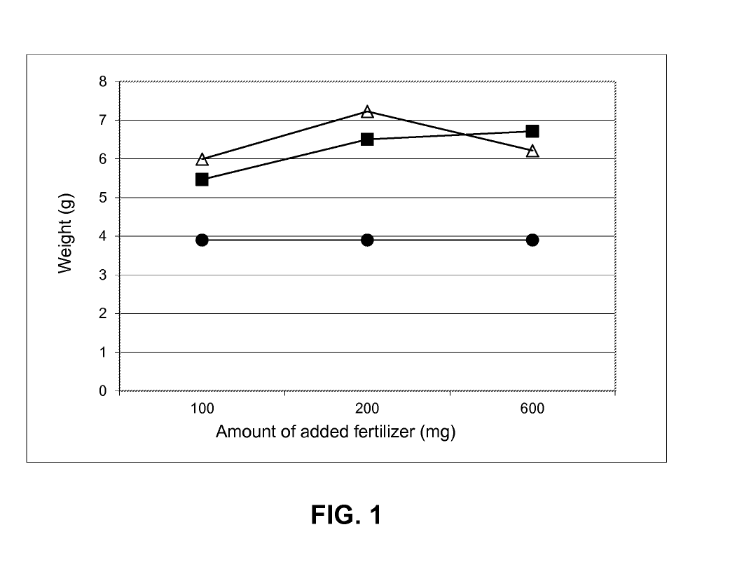

The total biomass of the seedlings fertilized with the different fertilizers is displayed in FIG. 1. It was evident from the results that seedlings fertilized with the fertilizer according to Example 1 above had grown at least as much as seedlings fertilized with the commercially available fertilizer during the ten weeks. Further, when fertilized in an amount of 600 mg nitrogen, the fertilizer according to Example 1 above provided for better growth of the seedlings, thus indicating that the seedlings can tolerate a higher dose of a fertilizer according to Example 1 above compared to the commercially available fertilizer. This is important for the long-term effect of the fertilizer, i.e. a higher amount can be added to plants without causing toxic effects.

Hence, Example 2 shows that a fertilizer according to the present invention works as an excellent slow-release fertilizer for spruce seedlings.

1. Method for preparing a slow-release fertilizer comprising the steps of
a) providing a mixture comprising urea and a first lignin compound;
b) heating said mixture to a temperature in the range of 70-170° C. to obtain a reacted mixture;
c) forming said reacted mixture to obtain a fertilizer composition; and
d) forming a coating on said fertilizer composition; said coating comprising either at least one resin acid and at least one inorganic salt or a second lignin compound, to obtain said slow-release fertilizer.

2. Method according to claim 1, wherein the heating of step b) is to a temperature in the range of 125-135° C.

3. Method according to claim 1, wherein said first lignin compound is a lignosulphonate.

4. Method according to claim 3, wherein said lignosulphonate is sodium lignosulphonate or magnesium lignosulphonate.

5. Method according to claim 1, wherein said at least one resin acid is at least one modified resin acid.

6. Method according to claim 1, wherein said at least one inorganic salt has a solubility in water of less than 50 g/l at 20° C.

7. Method according to claim 1, wherein said at least one inorganic salt is a calcium salt.

8. Method according to claim 7, wherein said calcium salt comprises calcium sulphate and/or calcium hydroxyphosphate.

9. Method according to claim 7, wherein forming a coating comprising at least one resin acid and at least one calcium salt in step d) comprises subjecting the fertilizer composition to a calcium salt having a solubility in water of above 50 g/l at 20° C. and at least one salt of a resin acid.

10. Method according to claim 9, wherein said calcium salt is selected from calcium chloride, calcium nitrate and calcium acetate.

11. Method according to claim 1, wherein said second lignin compound is reacted with urea.

12. Method according to claim 1, wherein steps b) and c) are performed simultaneously.

13. Method according to claim 1, wherein said first and/or second lignin compound is provided by a method comprising the steps of:
a1) providing lignocellulosic material;
b1) subjecting said lignocellulosic material to delignification in alkaline conditions to obtain black liquor;
c1) evaporating said black liquor to obtain evaporated black liquor;
d1) subjecting at least part of said evaporated black liquor to carbon dioxide to precipitate said lignin compound; and
e1) recovering said lignin compound.

14. Method according to claim 1, wherein at least one salt having a solubility in water of about 50-300 g/l at 20° C. is added to said mixture in step a) and/or to said reacted mixture in step b).

15. Method according to claim 14, wherein said salt is selected from the group consisting of magnesium sulphate, magnesium oxalate and ammonium oxalate.

16. Method according to claim 1, wherein said mixture of step a) is further comprising an acid.

17. Method according to claim 1, wherein said forming of step c) is pelletization or granulation.

18. (canceled)

19. Method of preparing a fertilizer comprising a lignin compound and urea, wherein said lignin compound is obtained by a method comprising the steps of:
a2) providing lignocellulosic material;
b2) subjecting said lignocellulosic material to delignification in alkaline conditions to obtain black liquor;
c2) evaporating said black liquor to obtain evaporated black liquor;
d2) subjecting at least part of said evaporated black liquor to carbon dioxide to precipitate said lignin compound; and
e2) recovering said lignin compound.

20.-27. (canceled)

28. Method of coating a fertilizer with a coating comprising a lignin compound, or said lignin compound reacted with urea, wherein said lignin compound is obtained by a method comprising the steps of:
a4) providing lignocellulosic material;
b4) subjecting said lignocellulosic material to delignification in alkaline conditions to obtain black liquor;
c4) evaporating said black liquor to obtain evaporated black liquor;
d4) subjecting at least part of said evaporated black liquor to carbon dioxide to precipitate said lignin compound; and
e4) recovering said lignin compound.
